(19) United States
(12) Patent Application Publication
(10) Pub. No.: US 2026/0287538 A1
(43) Pub. Date: Sep. 24, 2026

(54) POTENTIAL MEASUREMENT SYSTEM FOR MICROFLUIDIC CHANNEL

(71) Applicants: PROVALABS, INC., Seoul (KR); SEOUL NATIONAL UNIVERSITY R&DB FOUNDATION, Seoul (KR)

(72) Inventors: Sung Jae KIM, Seoul (KR); Taewan KIM, Gyeonggi-do (KR); Joowon SEO, Seoul (KR); Sungjae HA, Gyeonggi-do (KR)

(21) Appl. No.: 19/166,048

(22) PCT Filed: Mar. 14, 2024
(86) PCT No.: PCT/KR2024/003268

§ 371 Date: Sep. 17, 2025

(30) Foreign Application Priority Data
Mar. 17, 2023 (KR) 10-2023-0035420
Mar. 13, 2024 (KR) 10-2024-0035444

(51) Int. Cl. G01N 27/10; B01L 3/00; G01N 27/30; G01N 27/333; G01N 27/416

(52) U.S. Cl. CPC G01N 27/10; B01L 3/502715; G01N 27/301; G01N 27/333; G01N 27/416; B01L 2300/0645

(57) ABSTRACT

Embodiments of the present invention relate to a potential measurement system for a microfluidic channel. The potential measurement system for a microfluidic channel according to the embodiments of the present invention may comprise: a microchannel into which a sample solution containing a sample is injected; a probe channel including a reservoir into which a buffer solution is injected, and an ion exchange membrane which extends from at least a portion of the reservoir and has an end connected to the microchannel; a measurement electrode which is electrically connected to the reservoir; and a measurement unit which applies a feedback voltage to the reservoir through the measurement electrode and measures a potential at a target location within the microchannel on the basis of the applied feedback voltage.

### TECHNICAL FIELD

Embodiments of the present invention relate to a potential measurement system for a microfluidic channel.

### BACKGROUND ART

Technology for measuring a potential value at an arbitrary point within a microfluidic channel enables the inference of information such as concentration and electric field at that point, and therefore such technology may be widely used in various applications which utilize a microfluidic system.

However, a microfluidic channel exhibits greater electrical resistance as the size thereof decreases and as the concentration of an electrolyte decreases, which results in a limitation where the accuracy of potential measurement is reduced due to current division into a measurement device when the input impedance of the measurement device is comparable to or lower than the channel resistance.

Additionally, due to various properties of the microfluidic channel other than the property as described above, it has been challenging to accurately measure a potential at a specific point using conventional general potential measurement methods.

### DISCLOSURE

### Technical Problem

An embodiment of the present invention provides a potential measurement system for a microfluidic channel which is capable of more accurately measuring a potential at a specific point within the microfluidic channel.

### Technical Solution

A potential measurement system for a microfluidic channel according to the present invention may include: a microchannel into which a sample solution containing a sample is injected; a probe channel including a reservoir into which a buffer solution is injected, and an ion exchange membrane which extends from at least a portion of the reservoir and has an end connected to the microchannel; a measurement electrode electrically connected to the reservoir; and a measurement unit applying a feedback voltage to the reservoir through the measurement electrode and measuring a potential at a target location within the microchannel on the basis of the applied feedback voltage.

In the potential measurement system for a microfluidic channel according to an embodiment, the ion exchange membrane may have cation-selective permeability.

In the potential measurement system for a microfluidic channel according to an embodiment, the ion exchange membrane may be Nafion.

In the potential measurement system for a microfluidic channel according to an embodiment, the ion exchange membrane may have anion-selective permeability.

In the potential measurement system for a microfluidic channel according to an embodiment, the measurement electrode may be a silver chloride (Ag/AgCl) reference electrode.

In the potential measurement system for a microfluidic channel according to an embodiment, the buffer solution may include KCl.

In the potential measurement system for a microfluidic channel according to an embodiment, the probe channel may include a plurality of probe channels.

In the potential measurement system for a microfluidic channel according to an embodiment, the ion exchange membrane may be connected to the microchannel such that the end of the ion exchange membrane encloses at least a portion of outer surfaces of the microchannel.

In the potential measurement system for a microfluidic channel according to an embodiment, a cross section of the microchannel may be rectangular, and the ion exchange membrane may be connected to the microchannel such that the end of the ion exchange membrane encloses at least three of the outer surfaces of the microchannel.

In the potential measurement system for a microfluidic channel according to an embodiment, the measurement unit may apply the feedback voltage to the reservoir such that current in the ion exchange membrane becomes zero current.

### Advantageous Effects

According to an embodiment of the present invention, a potential measurement system for a microfluidic channel which is capable of more accurately measuring a potential at a specific point within the microfluidic channel may be provided.

### DESCRIPTION OF DRAWINGS

FIG. 1 is a diagram illustrating a potential measurement system for a microfluidic channel according to an implementation of the present invention.

FIG. 2 is a diagram illustrating a potential measurement system including a plurality of probe channels, according to an embodiment of the present invention.

FIG. 3 is a diagram illustrating the connection relationship between an ion exchange membrane and a microchannel according to an embodiment of the present invention in detail.

FIG. 4 is a cross-sectional view taken in direction A in FIG. 3.

FIG. 5 shows diagrams illustrating a potential measurement system including a plurality of probe channels, according to an embodiment of the present invention, and a voltage measured at each target location of the system over time.

FIG. 6 shows diagrams illustrating an example of measuring the concentration of a sample solution injected into a microchannel using a potential measurement system according to an implementation of the present invention.

### BEST MODES OF THE INVENTION

Specific structural or functional descriptions disclosed herein are merely illustrative for the purpose of describing embodiments according to the technical spirit of the present invention. Embodiments according to the technical spirit of the present invention may be implemented in various forms in addition to the embodiments disclosed herein, and should not be construed as being limited to the specific embodiments set forth herein.

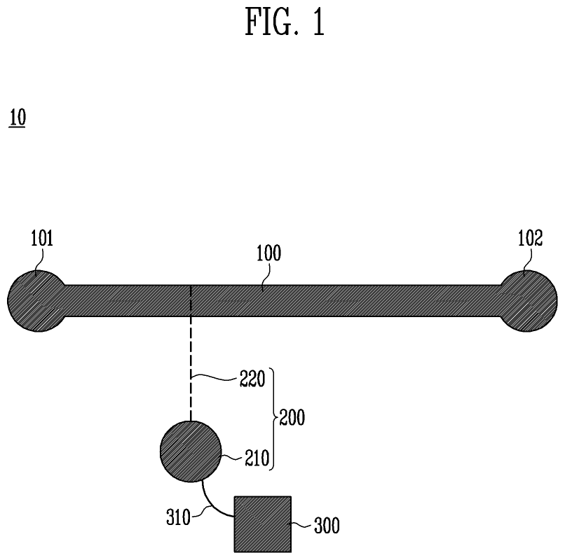

FIG. 1 is a diagram illustrating a potential measurement system for a microfluidic channel according to an implementation of the present invention.

Referring to FIG. 1, a potential measurement system 10 for a microfluidic channel according to an implementation of the present invention may include a microchannel 100, a probe channel 200 including a reservoir 210 and an ion exchange membrane 220, a measurement electrode 310, and a measurement unit 300.

In an embodiment, a sample solution containing a sample may be injected into the microchannel 100.

The sample may be, without limitation, protein, fluorescent particles, lipid nanoparticles, microbeads, or exosomes, and the diameter of particles of the sample may be in a range of several nm to several tens of μm. The sample solution may include the sample and a buffer solution. The buffer solution may be, without limitation, KCl, NaCl, Phosphate Buffered Saline (PBS), Tris Buffered Saline (TBS), or a mixture thereof.

In an embodiment, the microchannel 100 may include an inlet for injecting the sample solution at one end 101. The microchannel 100 may include an outlet for discharging the sample solution at another end 102. As a non-limiting example, the microchannel 100 may have an elongated shape which extends in one direction to have a structure which facilitates the movement of the sample solution along a path. The microchannel 100 may have an elongated shape which extends in one direction, and a cross section of the microchannel 100 at an arbitrary point which is taken in a direction perpendicular to the extension direction may be rectangular, square, circular, elliptical, trapezoidal, or triangular, but is not necessarily limited thereto. The extension direction of the microchannel 100 may be straight or curved.

Although referred to as the microchannel 100 in the present application, the microchannel 100 may generically refer to a microfluidic channel structure which receives a sample solution therein, thereby allowing fluid flow by an electric force or a capillary force, and may encompass all nano- or microscale channels without being limited to a specific shape. In an embodiment, when the cross section of the microchannel 100 is rectangular, square, triangular, or trapezoidal, the width may be 10 μm to 1000 μm, and the height may be 0.5 μm to 1000 μm. When the cross section of the microchannel 100 is elliptical or circular, the major axis may be 10 μm to 1000 μm, and the minor axis may be 0.5 μm to 1000 μm, but is not necessarily limited thereto.

In an embodiment, the microchannel 100 may include a flexible polymer material or rigid plastic. For example, a flexible polymer such as PDMS or rigid plastic such as acrylic or polycarbonate may be used as a material for the microchannel 100.

In an embodiment, a reference voltage V_{H} may be applied to the one end 101 of the microchannel 100. The reference voltage V_{H} may be a fixed voltage or a variable voltage. A control voltage V_{CTRL} which changes according to control, or a ground voltage V_{GND} may be applied to the other end 102 of the microchannel 100. To apply the reference voltage and control voltage as described above, an electrode (not shown) may be connected to each of the one end 101 and the other end 102 of the microchannel 100. However, the present invention is not necessarily limited thereto, and a potential difference may be formed between the opposite ends of the microchannel 100 due to various conditions such as application of current or flow to the microchannel 100 as needed.

As such, in the microchannel 100, a potential difference may be formed at the opposite ends under various conditions as described above to enable separation, concentration, or extraction of a sample material injected into the microchannel 100. As a result, an electric field may be formed in the microchannel 100 due to the potential difference between the opposite ends. Due to the potential difference formed by potentials applied to the opposite ends and a fluid in flow, such as the sample solution in the microchannel 100, each arbitrary point in the microchannel 100 may indicate a specific potential value at any given time point, which may change in real time. From the potential value at each arbitrary point within the microchannel 100, various pieces of information, such as an electric field at a corresponding point at a corresponding time point and the sample concentration of the sample solution passing through the corresponding point may be inferred.

In an embodiment, the probe channel 200 may include the reservoir 210 into which a buffer solution is injected, and the ion exchange membrane 220 which extends from at least a portion of the reservoir 210 and has an end connected to the microchannel 100. The probe channel 200 may be connected to the microchannel 100 by the end of the ion exchange membrane 220 being connected to the microchannel 100. A point where the end of the ion exchange membrane 220 is connected to the microchannel 100 within the microchannel 100 may serve as a target location at which a potential within the microchannel 100 is to be measured.

In an embodiment, a buffer solution may be injected into the reservoir 210. The buffer solution may be injected into the reservoir 210 and may be contained in the reservoir 210. The buffer solution may include, without limitation, KCl, NaCl, Phosphate Buffered Saline (PBS), Tris Buffered Saline (TBS), or a mixture thereof. Although not necessarily limited thereto, the buffer solution injected into the reservoir 210 may be an electrolyte having a composition corresponding to that of the buffer solution injected into the microchannel 100 and may be a buffer solution having the concentration corresponding to that of the buffer solution injected into the microchannel 100.

In an embodiment, the reservoir 210 may have a shape such as a sphere, cube, cuboid, cone, cylinder, truncated pyramid, pyramid, or prism, or may have a shape including two or more of the shapes as mentioned above, as needed. The reservoir 210 may include a flexible polymer material or rigid plastic. For example, a flexible polymer such as PDMS or rigid plastic such as acrylic or polycarbonate may be used as a material for the reservoir 210.

In an embodiment, the ion exchange membrane 220 may extend from at least a portion of the reservoir 210 and may have an end connected to the microchannel 100. The ion exchange membrane 220 may have an elongated shape which extends in one direction, and the extension direction may be straight or curved. The ion exchange membrane 220 may be in the form of a film.

The ion exchange membrane 220 is in communication with the reservoir 210, allowing the buffer solution injected into and contained in the reservoir 210 to move along the ion exchange membrane 220 and reach the connection point with the microchannel 100.

The ion exchange membrane 220 may be configured to suppress an ion concentration polarization (ICP) phenomenon caused by ion exchange, when a circuit between the microchannel 100 and the measurement unit 300 to be described below is formed to allow zero current or a very low level of current to flow mediated by ion movement. The ion exchange membrane 220 as described above may be implemented through the shape, patterning method, or the like of the ion exchange membrane 220 to be described below.

In an embodiment, the ion exchange membrane 220 may have ion-selective permeability.

In an embodiment, the ion exchange membrane 220 may have cation-selective permeability. The cation-selective permeability refers to the property where cations may pass through a boundary of the ion exchange membrane 220, while anions might not. Accordingly, the ion exchange membrane 220 may refer to a cation exchange membrane.

In an embodiment, the cation exchange membrane may be Nafion, PEDOT: PSS, a cation selective hydrogel (CSH), Neosepta CMX, or Fumapem (CEM). In a specific embodiment, the cation exchange membrane may be Nafion.

In an embodiment, the ion exchange membrane 220 may have anion-selective permeability. The anion-selective permeability may refer to the property where anions may pass through a boundary of the ion exchange membrane 220, while cations might not. Accordingly, the ion exchange membrane 220 may refer to an anion exchange membrane.

In an embodiment, the anion exchange membrane may be an anion selective hydrogel (ASH), Neosepta AMX, Fumapem (AEM), or AEM-Pention.

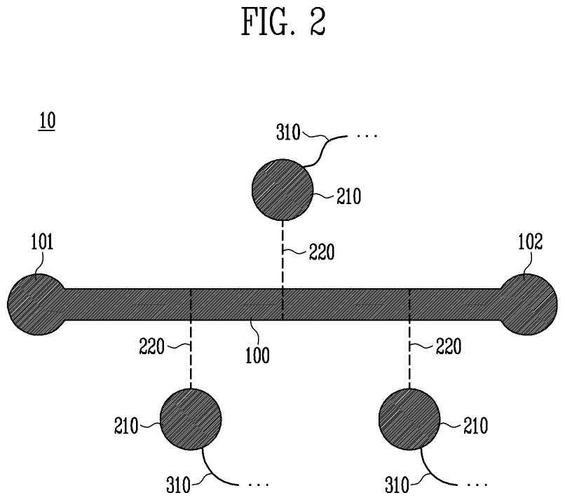

FIG. 2 is a diagram illustrating, in a potential measurement system for a microfluidic channel according to an implementation of the present invention, the system including a plurality of probe channels 200, according to an embodiment.

Referring to FIG. 2, the potential measurement system 10 for a microfluidic channel according to an implementation of the present invention may include one or more probe channels 200 in an embodiment. When the system 10 includes one or more probe channels 200, the ion exchange membranes 220 of the one or more probe channels 200 may be connected to the microchannel 100 at different target locations, respectively. Through the configuration of the respectively connected probe channels 200, potentials at a plurality of target locations where the ion exchange membranes 220 of the respective probe channels 200 are connected may be measured individually.

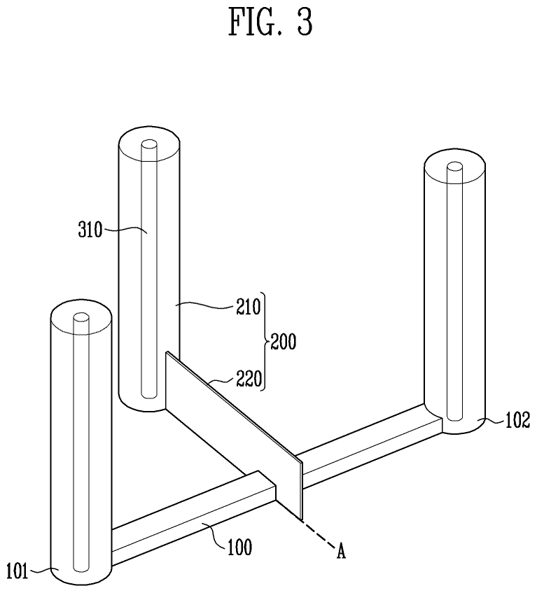

FIG. 3 is a diagram illustrating the connection relationship between the ion exchange membrane 220 and the microchannel 100 according to an embodiment of the present invention in detail.

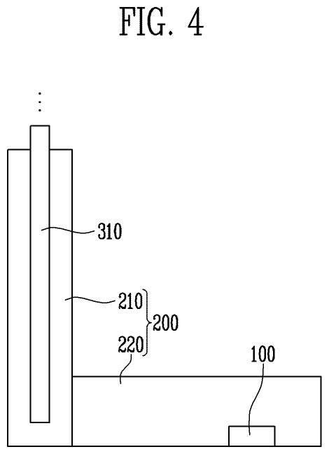

FIG. 4 is a cross-sectional view taken in direction A in FIG. 3.

FIGS. 3 and 4 are diagrams illustrating the connection relationship between the ion exchange membrane 220 and the microchannel 100 according to an embodiment of the present invention in detail.

In the potential measurement system 10 for a microfluidic channel according to an implementation of the present invention, in an embodiment, the ion exchange membrane 220 may be connected to the microchannel 100 such that an end of the ion exchange membrane 220 encloses at least a portion of outer surfaces of the microchannel 100.

Referring to FIGS. 3 and 4, in an embodiment, a cross section of the microchannel 100 may be rectangular, and the ion exchange membrane 220 may be connected to the microchannel 100 such that the end of the ion exchange membrane 220 encloses at least three of the outer surfaces of the microchannel 100. The cross section may refer to a plane which includes a vector perpendicular to an extension direction of the microchannel 100 at an arbitrary point in the microchannel 100.

Through the connection relationship as described above, the interfacial resistance at the connection point between the end of the ion exchange membrane 220 and the microchannel 100 may be minimized, enabling more precise measurement of a potential at a target location. This may be attributed to the reduction in the interfacial energy when the connection between the end of the ion exchange membrane 220 and the microchannel 100 is established in the manner as described above, compared to when the connection is simply established by point contact, line contact, or contact over a single surface. Additionally, the shape of the ion exchange membrane 220 and the connection relationship between the ion exchange membrane 220 and the microchannel 100 may enable smooth optical observation.

Referring back to FIG. 1, the potential measurement system 10 for a microfluidic channel according to an implementation of the present invention includes the measurement electrode 310 which is electrically connected to the reservoir 210, and the measurement unit 300 which applies a feedback voltage to the reservoir 210 through the measurement electrode 310 and measures a potential at a target location within the microchannel 100 on the basis of the applied feedback voltage.

In an embodiment, the measurement electrode 310 may be electrically connected to the reservoir 210. The statement that the measurement electrode 310 is electrically connected to the reservoir 210 may mean that the measurement electrode 310 is connected such a manner as to provide a specific electrical environment (e.g., a specific potential) to the reservoir 210, or to enable measurement of parameters related to an electrical environment within the reservoir 210.

In an embodiment, the measurement electrode 310 may be a silver chloride (Ag/AgCl) reference electrode.

In an embodiment, the measurement unit 300 may apply a feedback voltage to the reservoir 210 through the measurement electrode 310 and measure a potential at a target location within the microchannel 100 on the basis of the applied feedback voltage.

In an embodiment, the measurement unit 300 may apply a feedback voltage to the reservoir 210 such that current in the ion exchange membrane 220 becomes zero current.

In an embodiment, when the probe channel 200 includes a plurality of probe channels, the measurement unit 300 may be provided such a manner as to correspond to each probe channel 200 in a one-to-one manner. Each measurement unit 300 corresponding to each probe channel 200 in a one-to-one manner may apply each feedback voltage to the reservoir 210 of the corresponding probe channel 200 and measure a potential at each target location on the basis of the feedback voltage applied to each reservoir 210.

Alternatively, when the probe channel 200 includes a plurality of probe channels, the measurement unit 300 may be provided such a manner as to correspond to each of a plurality of groups each including one or more probe channels 200. The measurement unit 300 corresponding to each group may apply each feedback voltage to one or more probe channels 200 included in the corresponding group and measure a potential at each target location on the basis of the applied feedback voltage.

Alternatively, when the probe channel 200 includes a plurality of probe channels, only one measurement unit 300 may be provided. The measurement unit 300 may apply each feedback voltage to each probe channel 200 and measure a potential at each target location on the basis of the applied feedback voltage.

Hereinafter, a method for measuring a potential at a target location within the microchannel 100 using the measurement unit 300 is described.

As described above, an end of the ion exchange membrane 220 may be connected to a target location within the microchannel 100. The other end of the ion exchange membrane 220 may be in communication with the reservoir 210, which is electrically connected to the measurement electrode 310.

The measurement unit 300 may apply current or voltage to the reservoir 210 through the measurement electrode 310. When a voltage is applied to the reservoir 210, current may be generated due to the potential difference between the reservoir 210 and the target location within the microchannel 100. Such current may be generated due to the movement of ions in the buffer solution within the reservoir 210 and the ion exchange membrane 220.

The measurement unit 300 may measure the current generated within the ion exchange membrane 220 or the reservoir 210 in response to the voltage applied to the reservoir 210. The current may be measured through a current measurement means, such as an ammeter, connected separately to the ion exchange membrane 220 or the reservoir 210, or the current may be measured directly from the reservoir 210.

The measurement unit 300 may adjust the voltage applied to the reservoir 210 on the basis of the measured current value. That is, the measurement unit 300 may apply a feedback voltage to the reservoir 210. The measurement unit 300 may apply the feedback voltage such that the current measured in the ion exchange membrane 220 or the reservoir 210 becomes zero or very close to zero, i.e., zero current.

The measurement unit 300 may measure a potential at the target location on the basis of the feedback voltage. The statement that the current measured in the ion exchange membrane 220 or the reservoir 210 becomes zero current due to the application of the feedback voltage may mean, in other words, that the total effective ion transport across the ion exchange membrane 220 connected to the target location of the microchannel 100 is zero or very close to zero. Accordingly, the potential difference between a potential of the reservoir 210 and the potential at the target location becomes zero or very close to zero, enabling the potential at the target location to be measured by approximating the feedback voltage applied to the reservoir 210.

When a probe connected to the target location is configured as a general metal electrode, unlike in an embodiment of the present invention, the current generated by the potential difference between opposite ends of the probe during the voltage application is caused by the movement of electrons, which may induce unnecessary side reactions at an electrode interface. For example, a chemical species injected into the microchannel 100 may be unnecessarily oxidized or reduced at the electrode interface, leading to the generation of byproducts that contaminate the sample solution within the microchannel 100, or the formation of bubbles that disrupt the connection within the microchannel 100. Such side reactions may further locally alter or destabilize an electrical environment at the target location within the microchannel 100, making accurate potential measurement at the target location extremely difficult.

The probe channel 200 according to an embodiment of the present invention includes the ion exchange membrane 220 in a portion connected to the target location, such that when the potential difference occurs between the opposite ends, ions rather than electrons move. Therefore, accurate potential measurement at the target location may be achieved without the risk of the aforementioned side reactions occurring.

According to an embodiment of the present invention, when the ion exchange membrane 220 has cation-selective permeability, only cations may move in an environment where the potential difference exists between the reservoir 210 and the target location. According to an embodiment of the present invention, when the ion exchange membrane 220 has anion-selective permeability, only anions may move in an environment where the potential difference exists between the reservoir 210 and the target location.

Without limitation, the measurement unit 300 may include a source measurement unit such as KEITHLEY, but is not necessarily limited thereto, and may be separately provided, combined, or additionally provided with at least one of a multimeter, a voltage supply, a current source, a pulse generator, or a load, as needed.

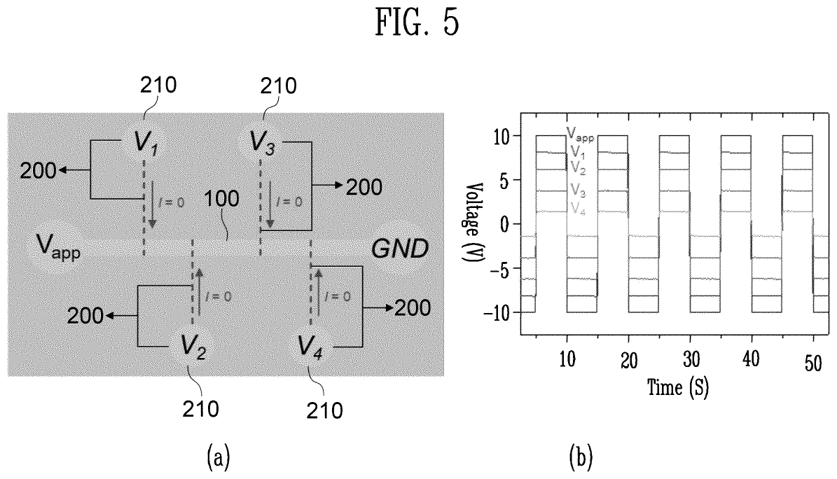

FIG. 5 shows diagrams illustrating a potential measurement system including a plurality of probe channels 200, according to an embodiment of the present invention, and a voltage measured at each target location of the system over time.

Specifically, FIG. 5 shows diagram (a) illustrating the relationship between the configurations of four probe channels 200 connected at four points, with a 10 Vₚₚ, 100 mHz square wave applied at opposite ends of the microchannel 100, and graph (b) showing a feedback voltage measured at the reservoir 210 of each probe channel 200 when zero current is applied to each target point. Each voltage (V₁, V₂, V₃, or V₄) may be the feedback voltage applied to each reservoir 210. As shown in FIG. 5, it is observed that in the potential measurement system according to an implementation of the present invention, accurate potential measurement is achieved at each point according to the voltage distribution at that point.

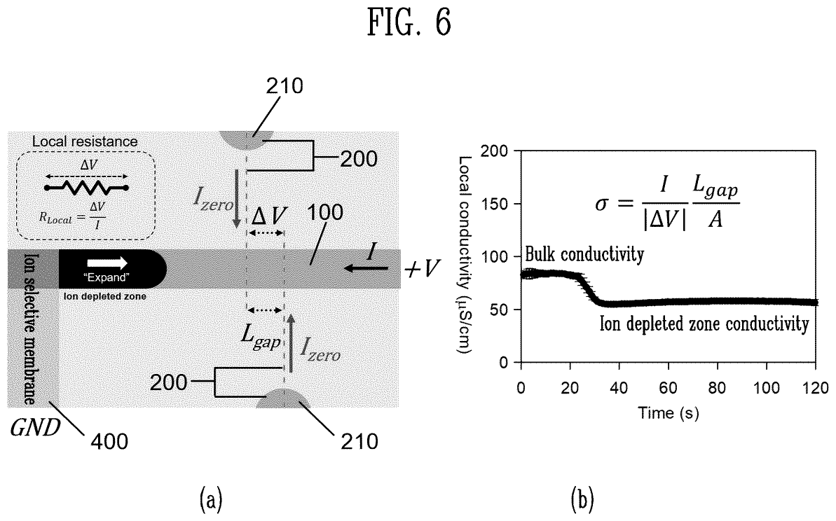

FIG. 6 shows diagrams illustrating an example of measuring the concentration of a sample solution injected into the microchannel 100 using a potential measurement system according to an implementation of the present invention.

Diagram (a) of FIG. 6 illustrates a system in which a pair of probe channels 200 for potential measurement and an ion selective membrane 400 are connected to the microchannel 100. When a voltage is applied to opposite ends of the microchannel 100, an ion depleted zone gradually expands, and a potential change at a corresponding point may be observed due to a change in ion concentration within the microchannel 100 caused by the expansion. By applying zero current to each of the pair of probe channels 200 separated by an arbitrary distance L, a potential at a target location of each probe channel 200 may be measured in real time. By measuring a potential difference AV in a local region between the pair of separated probe channels 200, the electrical conductivity of the local region may be calculated. Graph (b) of FIG. 6 shows a change in electrical conductivity o over time in the local region by the system as described above. Accordingly, a change in electrolyte concentration in the local region within the microchannel 200 may be measured in real time.

The potential measurement system according to an implementation of the present invention may be applied to a device including a single microchannel 100. Alternatively, the potential measurement system according to an implementation of the present invention may be applied to a device including a plurality of microchannels 100. Alternatively, the potential measurement system according to an implementation of the present invention may be applied to a device including the microchannel 100 of a networking structure. For example, the potential measurement system according to an implementation of the present invention may be applied to a device having a radial networking structure in which a plurality of microchannels 100 share one end.

Although the present invention has been described in reference to embodiments of the present invention as above, such embodiments are merely provided to facilitate a more general understanding of the present invention and are not intended to limit the scope of the present invention. Those skilled in the art to which the present invention pertains can make various modifications and changes based on the above description.

Accordingly, the scope of the spirit of the present invention shall be deemed to include not only the appended claims but also all those that are equivalent to the appended claims or equivalent modifications of the appended claims.

1. A potential measurement system for a microfluidic channel comprising:
a microchannel into which a sample solution containing a sample is injected;
a probe channel including a reservoir into which a buffer solution is injected, and an ion exchange membrane which extends from at least a portion of the reservoir and has an end connected to the microchannel;
a measurement electrode electrically connected to the reservoir; and
a measurement unit applying a feedback voltage to the reservoir through the measurement electrode and measuring a potential at a target location within the microchannel on the basis of the applied feedback voltage.

2. The potential measurement system for a microfluidic channel of claim 1, wherein the ion exchange membrane has cation-selective permeability.

3. The potential measurement system for a microfluidic channel of claim 2, wherein the ion exchange membrane is Nafion.

4. The potential measurement system for a microfluidic channel of claim 1, wherein the ion exchange membrane has anion-selective permeability.

5. The potential measurement system for a microfluidic channel of claim 1, wherein the measurement electrode is a silver chloride (Ag/AgCl) reference electrode.

6. The potential measurement system for a microfluidic channel of claim 1, wherein the buffer solution includes KCl.

7. The potential measurement system for a microfluidic channel of claim 1, wherein the probe channel includes a plurality of probe channels.

8. The potential measurement system for a microfluidic channel of claim 1, wherein the ion exchange membrane is connected to the microchannel such that the end of the ion exchange membrane encloses at least a portion of outer surfaces of the microchannel.

9. The potential measurement system for a microfluidic channel of claim 8, wherein a cross section of the microchannel is rectangular, and
wherein the ion exchange membrane is connected to the microchannel such that the end of the ion exchange membrane encloses at least three of the outer surfaces of the microchannel.

10. The potential measurement system for a microfluidic channel of claim 1, wherein the measurement unit applies the feedback voltage to the reservoir such that current in the ion exchange membrane becomes zero current.
